(19) United States
(12) Patent Application Publication
(10) Pub. No.: US 2015/0235589 A1
(43) Pub. Date: Aug. 20, 2015

(54) DISPLAY DEVICE AND DRIVING METHOD THEREOF

(71) Applicant: Electronics and Telecommunications Research Institute, Daejeon (KR)

(72) Inventors: Seong-Mok CHO, Daejeon (KR); Yong Hae KIM, Daejeon (KR); Tae-Youb KIM, Daejeon (KR); Chil Seong AH, Daejeon (KR); Juhee SONG, Daejeon (KR); Hojun RYU, Seoul (KR); Hye Yong CHU, Daejeon (KR)

(73) Assignee: Electronics and Telecommunications Research Institute, Daejeon (KR)

(21) Appl. No.: 14/619,139

(22) Filed: Feb. 11, 2015

(30) Foreign Application Priority Data
Feb. 19, 2014 (KR) 10-2014-0019133
Nov. 26, 2014 (KR) 10-2014-0166546

(51) Int. Cl. G09G 3/20; G09G 3/32

(52) U.S. Cl. CPC G09G 3/2003; G09G 3/3208; G09G 2310/0243; G09G 2310/0281

(57) ABSTRACT

Provided are a display device and a driving method thereof. The driving method of a display device including first pixels emitting lights or transmitting and reflecting an external light, and second pixels corresponding to the first pixels respectively, includes calculating light emission amounts necessary for the respective first pixels for realizing an image signal, receiving the light information on the amount of the external light incident to the first and second pixels, calculating a reflection light amount of a reflection device according to the external light amount, comparing the light emission amounts necessary for the respective first pixels with the reflection light amount, and adjusting light emission amounts of the respective first pixels according to a result of the comparing.

### CROSS-REFERENCE TO RELATED APPLICATIONS

This U.S. non-provisional patent application claims priority under 35 U.S.C. §119 of Korean Patent Application Nos. 10-2014-0019133, filed on Feb. 19, 2014, and 10-2014-0166546, filed on Nov. 26, 2014, the entire contents of which are hereby incorporated by reference.

### BACKGROUND OF THE INVENTION

The present invention disclosed herein relates to a display device and a driving method thereof, and more particularly, to a display device and driving method thereof capable of improving display quality.

Typical displays represent colors using three primary colors of red, green, and blue. Accordingly, a display panel used for the typical display includes red, green, and blue pixels displaying red, green, and blue colors.

Recently, a display device is being developed which displays color using red, green, blue and primary colors. The primary color may be any one of magenta, cyan, yellow, and white, or two or more of them. In addition, in order to improve luminance of a display image, a display device is being developed which includes red, green, blue, and white pixels. Such a display device receives red, green, and blue image signals and converts them into red, green, blue, and white data signals.

The red, green, blue, and white data signals are provided to corresponding red, green, blue, and white pixels, respectively. As a result, an image is displayed with the red, green, blue, and white pixels.

### SUMMARY OF THE INVENTION

The present invention provides a display device and a driving method thereof for compensating for a contrast ratio and power consumption.

Embodiments of the present invention provide display devices including: a first display panel including first pixels emitting lights or transmitting an external light and a reflection mirror disposed on a bottom portion of the first pixels and reflecting the external light; a second display panel adjusting a transmission rate of the external light reflected by the reflection mirror and including second pixels corresponding to the first pixels respectively; an optical sensor measuring amounts of the external lights applied to the first and second display panels and outputting light information corresponding to the external light amounts; a timing controller creating a first data control signal for adjusting light emission amounts of the first pixels and a second data control signal for adjusting transmission rates of the second pixels according to the light information; a first gate driver providing a first gate signal for driving the first pixels; a first data driver providing first data voltages for adjusting the light emission amounts of the first pixels in response to the first data control signal; a second gate driver providing a second gate signal for driving the second pixels; and a second data driver providing second data voltages for adjusting the light emission amounts of the second pixels in response to the second data control signal.

In some embodiments, the reflection mirror may be a color selective reflection mirror for applying colors to the external light.

In other embodiments, the first display panel may further include a color filter applying colors to the lights or the external light.

In still other embodiments, the first display panel may be an organic light emitting display panel.

In even other embodiments, the second display panel may be a liquid crystal display panel.

In yet other embodiments, the second display panel may be disposed over a top portion of the first display panel, and the first and the second pixels may have one-to-one correspondence.

In further embodiments, when the external light amount is greater than the light emission amounts of the first pixels, the timing controller may stop driving the first display panel and adjust light transmission rates of the second pixels to display images through reflection light by the reflection mirror according to the light information.

In other embodiments of the present invention, driving methods of a display device including first pixels emitting lights or transmitting and reflecting an external light and second pixels corresponding to the first pixels, respectively, are provided. The driving method includes: calculating light emission amounts necessary for the respective first pixels for displaying an image signal; receiving light information on the amount of the external light incident to the first and second pixels; calculating a reflection light amount of a reflection device according to external light amount; comparing the light emission amounts necessary for the respective first pixels with the reflection light amount; and adjusting the light emission amounts of the respective first pixels according to a result of the comparing.

In some embodiments, in the adjusting of the light emission amounts, the second pixels transmit lights may be output from the first pixels.

In other embodiments, the driving method may further include displaying the image signal by stopping the light emission of the first pixels and adjusting transmission rates of the respective second pixels to control the reflection light amount, when the light emission amounts necessary for the respective first pixels are less than the reflection light amount.

In still other embodiments, the reflection device may be a color selective reflection mirror.

In even other embodiments, the reflection device may include a reflection mirror and a color filter.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram of a display device according to an embodiment of the invention;

FIG. 2 is a block diagram illustrating a display panel structure according to a first embodiment of the present invention;

FIG. 3 is a block diagram illustrating a display panel structure according to a second embodiment of the present invention;

FIG. 4 is a block diagram illustrating a display panel structure according to the second embodiment of the present invention;

FIG. 5 is a block diagram illustrating a display panel structure according to the third embodiment of the present invention;

FIG. 6 is a timing diagram illustrating a driving method of a display device according to an embodiment of the present invention;

FIG. 7 is a graph showing an image displaying method according to a first embodiment of the present invention;

FIG. 8 is a graph showing an image displaying method according to a second embodiment of the present invention; and

FIG. 9 is a graph showing an image displaying method according to a third embodiment of the present invention.

### DETAILED DESCRIPTION OF PREFERRED EMBODIMENTS

Advantages and features of the present invention, and methods for achieving the same will be cleared with reference to exemplary embodiments described later in detail together with the accompanying drawings. However, the present invention is not limited to the following exemplary embodiments, but realized in various forms. In other words, the present exemplary embodiments are provided just to complete disclosure the present invention and make a person having an ordinary skill in the art understand the scope of the invention. The present invention should be defined by only the scope of the accompanying claims. Throughout this specification, like numerals refer to like elements.

When an element or a layer is referred to as being ‘on’ another element or layer, it can be directly on the other element or layer, or intervening layers or elements may also be present. In contrast, when an element or layer is referred to as being “directly on” another element or layer, there are no intervening elements or layers present. The term “and/or” includes any and all combinations of each and one or more of the associated listed items.

Spatially relative terms, such as “above,” “upper,” “beneath,” “below,” “lower,” and the like, may be used herein for ease of description to describe one element or feature's relationship to other elements or features as illustrated in the figures. It will be understood that the spatially relative terms are intended to encompass different orientations of the device in use or operation in addition to the orientation depicted in the figures. Throughout this specification, like numerals refer to like elements.

Also, though terms like a first and a second are used to describe various members, components, and/or sections in various embodiments of the present invention, the members, components, and/or sections are not limited to these terms. These terms are used only to differentiate one member, component, or section from another one. Therefore, a first element, a first component, or a first section referred to below can be referred to as a second element, a second component, or a second section within technical spirit of the present disclosure.

Example embodiments are described herein with reference to cross-sectional views and/or plan views that are schematic illustrations of example embodiments. As such, variations from the shapes of the illustrations as a result, for example, of manufacturing techniques and/or tolerances, are to be expected. Thus, example embodiments should not be construed as limited to the particular shapes of regions illustrated herein but may be to include deviations in shapes that result, for example, from manufacturing. Thus, the regions illustrated in the figures are schematic in nature and their shapes may be intended to illustrate the actual shape of a region of a device and are not intended to limit the scope of example embodiments.

Hereinafter, it will be described in detail about an exemplary embodiment of the present invention in conjunction with the accompanying drawings.

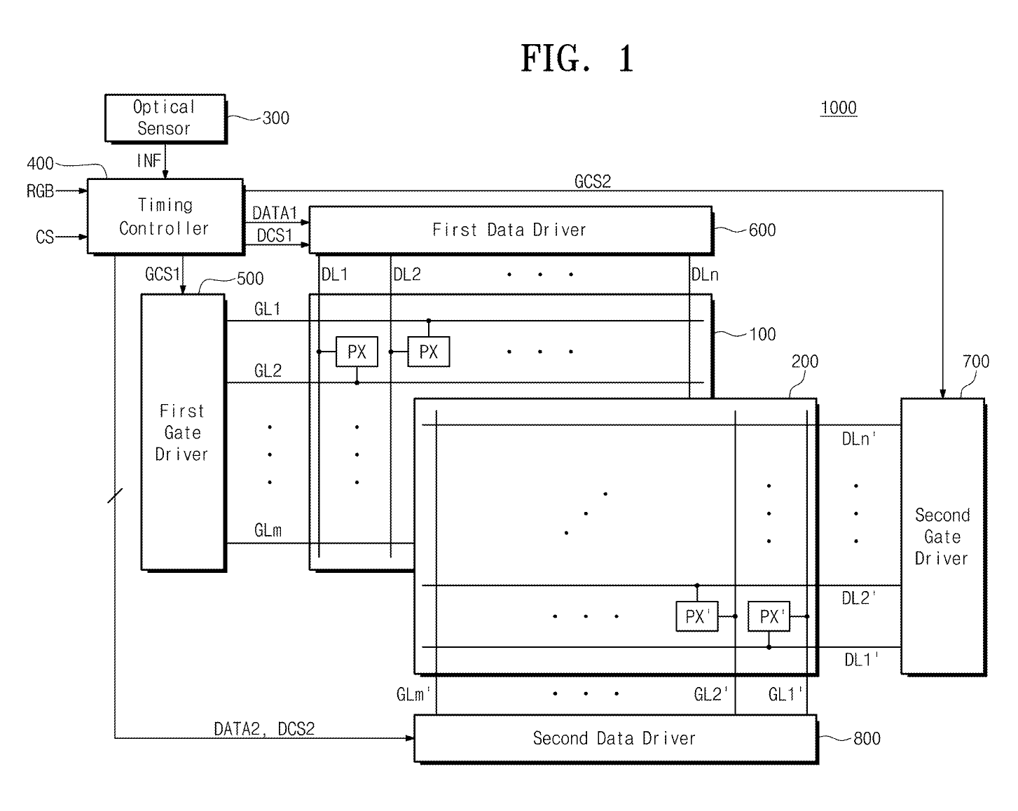

FIG. 1 is a block diagram of a display device according to an embodiment of the invention. Referring to FIG. 1, a display device 1000 according to an embodiment of the present invention may include a first display panel 100, a second display panel 200, an optical sensor 300, a timing controller 400, a first gate driver 500, a first data driver 600, a second gate driver 700, and a second data driver 800.

The first display panel 100 may be an organic light emitting display panel which is a self-emission display panel. When the first display panel 100 is an organic light emitting display panel, an organic light emitting layer between an anode electrode and a cathode electrode emits white light, and the white light may be changed into a light having specific color while passing a color filter. A backlight unit is not necessary which provides light to the first display panel 100. The first display panel 100 may be a transparent panel and transmit external light. A color selective reflection mirror (not illustrated) or a reflection mirror for reflecting the external light may be further included on the bottom portion of the first display panel 100.

The first display panel 100 includes a plurality of first gate lines GL1 to GLm, where m is a natural number of 2 or greater, a plurality of first data lines DL1 to DLn, where n is a natural number 2 or greater, and a plurality of first pixels PX.

The first display panel 100 may include the first gate lines GL1 to GLm extending in a first direction DR1 and the first data lines DL1 to DLn extending in a second direction DR2 intersecting with the first direction DR1. The first direction DR1 may correspond to a row direction and the second direction DR2 may correspond to a column direction.

The first pixels PX may be arranged on regions divided by the first gate lines GL1 to GLm and the first data lines DL1 to DLn intersecting with each other. Accordingly, the first pixels PX may be arranged in a matrix type.

The first pixels PX are connected to corresponding first gate lines GL1 to GLm and corresponding first data lines DL1 to DLn. A color selective reflection mirror (not illustrated), or a reflection mirror and a color filter for providing specific color may be included in the bottom portions of the first pixels PX.

Each of the color selective reflection mirror and color filter may display one of primary colors. The primary colors may include red, green, blue, and white colors. However, the primary colors are not limited hereto and may further include various colors such as yellow, cyan, and magenta. In addition, each of the first pixels according to an embodiment of the present invention may display one or more of primary colors.

The second display panel 200 include a plurality of second gate lines GL1′ to GLm′, a plurality of second data lines DL1′ to DLn′, and a plurality of second pixels PX′. The second display panel 200 may be a liquid crystal display panel. The second display panel 200 may be a transparent panel and transmit external light. The second display panel 200 may adjust light transmission rate through driving liquid crystal molecules.

The second pixels PX′ is located to correspond to the first pixels PX. The second pixels PX′ may be arranged on regions divided by the second gate lines GL1′ to GLm′ and the second data lines DL1′ to DLn′ intersecting with each other. Accordingly, the second pixels PX′ may be arranged in a matrix type.

Each of the second pixels PX′ may operate as an optical shutter. Accordingly, the second display panel 200 may control a transmission rate of the external light that is reflected by a color selective reflection mirror or a reflection mirror according to controls of a timing controller 400.

The optical sensor 300 receives light from the outside. The optical sensor 300 may detect an amount of an external light corresponding to an image signal RGB. In detail, the optical sensor 300 may have selective sensing characteristic according to each optical wavelength. In addition, when the optical sensor 300 does not include wave selective characteristic, the optical sensor 300 may be implemented by being stacked with a color filter. The optical sensor 300 may detect an intensity of the external light corresponding to each wavelength and predict an intensity of a reflection light reflected through the color selective reflection mirror (not illustrated) or the reflection mirror (not illustrated). The optical sensor 300 outputs light information INF on the reflection light intensity to the timing controller 400.

The timing controller 400 receives image signals RGB and a control signal CS from the outside (e.g., a system board). The control signal may include a vertical sync signal which is a frame distinction signal, a horizontal sync signal which is a row distinction signal, a data enable signal that has a high level only during a data output period for displaying a region of data input, and a mail clock signal.

The timing controller 400 converts a data format of the image signals RGB to be matched with interface specification of the first and second data drivers 600 and 800. The timing controller 400 respectively provides, to the first and second data drivers 600 and 800, the first and second image data DATA1 and DATA2 whose data format is converted.

The timing controller 400 creates first and second gate control signals GCS1 and GCS2, and first and second data control signals DCS1 and DCS2 in response to the control signal CS. The first gate control signal GCS1 is a control signal for controlling an operation timing of the first gate driver 500. The second gate control signal GCS2 is a control signal for controlling the second gate driver 700.

The first data control signal DCS1 is a control signal for controlling an operation timing of the first data driver 600. The second data control signal DCS2 is a control signal for controlling an operation timing of the second data driver 800.

The first and second gate control signals GCS1 and GCS2 may include a scan start signal for instructing scan start, at least one clock signal for controlling an output period of a gate-on voltage, and an output enable signal for limiting a gate-on voltage duration.

The first and second data control signals DCS1 and DCS2 may include a horizontal start signal notifying a start to transmit the first and second image data DATA1 and DATA2 to the first and second data driver 600 and 800, a load signal that is a command signal for applying data voltages to the data lines DL1 to DLn and DL1′ to DLn′, and an inversion signal for inverting polarity of a data voltage with respect to a common voltage.

The timing controller 400 respectively provide the first and second gate control signals GCS1 and GCS2 to the first and second gate drivers 500 and 700. In addition, the timing controller 400 respectively provide the first and second data control signals DCS1 and DCS2 to the first and second gate drivers 600 and 800.

The timing controller 400 performs a control to create the first and second gate signals GCS1 and GCS2 and the first and second data control signals DCS1 and DCS2 according to light information received from the optical sensor 300.

The timing controller 400 may adjust a light emission amount of the first display panel 100 according to received light information. In addition, the timing controller 400 may adjust a reflection light amount transmitted to the second display panel 200.

According to light information INF, when the light emission amount of the first display panel 100 for displaying an image is greater than the reflection light amount, the timing controller 400 performs a control so that the first display panel 100 emits a light as much as a light amount difference in-between.

On the contrary, when an expected reflection light amount is greater than the light emission amount of the first display panel 100, the timing controller 400 stops light emission of the first display panel 100. In addition, the timing controller 400 may adjust the amount of the reflection light transmitted through the second display panel 200.

The first gate driver 500 creates a gate signal in response to the first gate control signal GCS1. The first gate driver 500 sequentially outputs the gate signal. The gate signal is provided to the first pixels PX in a unit of a row through the first gate lines GL1 to GLm.

The first data driver 600 generates analog data voltages that correspond to the first image data DATA1 in response to the first data control signal DCS1 and output the data voltages. The data voltages are provided to the first pixels PX in a unit of a column through the first data lines DL1 to DLn.

The second gate driver 700 creates a gate signal in response to the second gate control signal GCS2. The second gate driver 700 sequentially outputs the gate signal. The gate signal is provided to the second pixels PX′ in a unit of a row through the second gate lines GL1′ to GLm′.

The second data driver 800 generates analog data voltages that correspond to the second image data DATA2 in response to the second data control signal DCS2 and output the data voltages. The data voltages are provided to the second pixels PX′ in a unit of a column through the second data lines DL1′ to DLn′.

The first data control signal DCS1 controls the light emission amount 100 according to controls of the timing controller 400. In addition, the second data control signal DCS2 controls a reflection light transmission rate of the second display panel 200 according to controls of the timing controller 400.

Polarities of data voltages respectively applied to the pixels PX may be inverted at every frame to prevent degradation of the liquid crystal. For example, the first and second data drivers 600 and 800 may invert polarities of the data voltages at each frame in response to an inversion signal and output the data voltages. In addition, when an image of one frame is displayed, data voltages having different polarities are output at every two data lines and provided to the first and second pixels PX and PX′ for improving display quality.

The first and second pixels PX and PX′ may receive data voltages through the data lines DL1 to DLn and DL1′ to DLn′ in response to the gate signals received through the gate lines GL1 to GLm and GL1′ to GLm′. The first and second pixels PX and PX′ may display an image by displaying gradation corresponding to the data voltages.

The timing controller 400 may be mounted on a printed circuit board in an integrated circuit chip type and connected to the first and second gate drivers 500 and 700, and the first and second data drivers 600 and 800. The first and second gate drivers 500 and 700, and the first and second data drivers 600 and 800 may be formed of a plurality of driving chips and mounted on a flexible printed circuit board, and connected to the first and second display panels 100 and 200 in a tape carrier package TCP scheme.

Referring to FIG. 1, the first display panel 100 is located on the bottom portion of the second display panel 200. However, an embodiment of the present invention is not limited hereto. The first display panel 100 may be located on the top portion of the second display panel 200.

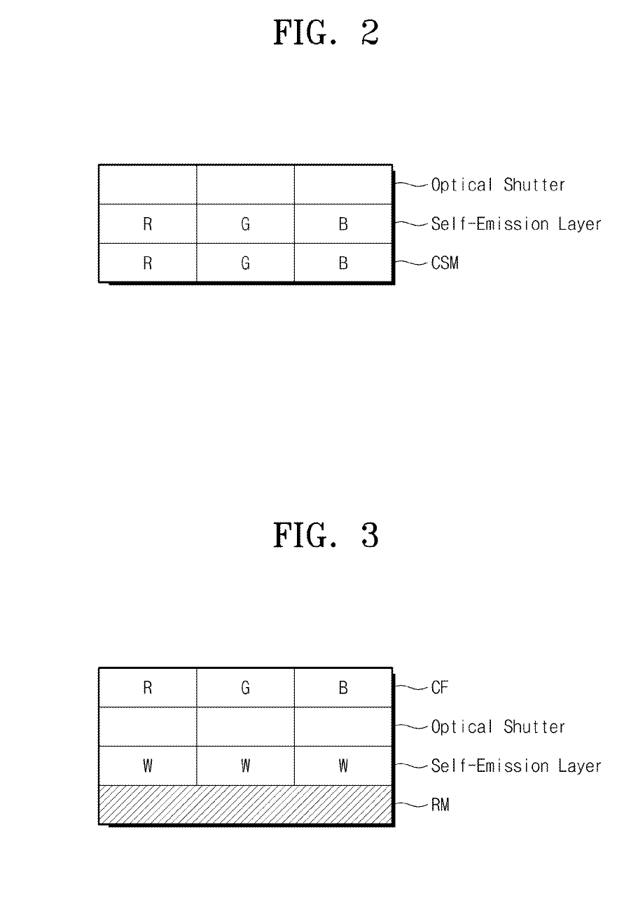

FIG. 2 is a block diagram illustrating a display panel structure according to a first embodiment of the present invention. Referring FIGS. 1 and 2, the first and second display panels 100 and 200 include a structure in which a color selective reflection mirror CSM, a self-emission layer including the first pixels PX, and an optical shutter including the second pixels PX′ are stacked.

The color selective reflection mirror CSM may reflect one of primary colors. The primary colors may include red R, green G, blue B, and white colors. However, the primary colors are not limited hereto and may further include yellow, cyan, and magenta. The color selective reflection mirror CSM may display an image by reflecting a light incident from the outside. The color selective reflection mirror CSM may provide colors to the reflection light.

The self-emission layer may be disposed between the color selective reflection mirror CSM and the optical shutter. The self-emission layer may include colors RGB respectively corresponding to the primary colors RGB of the color selective reflection mirror CSM. In addition, the transparent self-emission layer may include the first pixels PX capable of emitting visible light. The color selective reflection mirror CSM and the self-emission layer may be included in the first display panel 100.

The optical shutter may be disposed on the top portion of the self-emission layer. The optical shutter may be a liquid crystal display panel. The optical shutter may adjust a transmission rate of a light reflected by the color selective reflection mirror CSM through a control on the arrangement of liquid crystal molecules. The optical shutter may be the second display panel 200. Accordingly, the optical shutter operates in a unit of the second pixels PX′.

The first pixels PX of the self-emission layer may adjust a light emission amount according to a light amount sensed by the optical sensor 300. When an amount of an external light incident to the optical sensor 300 is less than a light emission amount of the first pixels PX, the first pixels PX emit lights as much as a light amount difference in-between.

On the contrary, when an amount of the external light incident to the optical sensor 300 is greater than a light emission amount of the first pixels PX, the first pixels PX stop light emission. In addition, an image may be displayed through a light reflected by the color selective reflection mirror CSM. In order to adjust the reflection light amount of the color selective reflection mirror SCM, the second pixels PX′ of the optical shutter drive the liquid crystal molecules to adjust the light transmission rate.

FIG. 2 discloses a structure in which the optical shutter is disposed on the top portion of the self-emission layer. However, an embodiment of the present invention is not limited hereto. The optical shutter may be disposed between the self-emission layer and the color selective reflection mirror CSM.

FIG. 3 is a block diagram illustrating a display panel structure according to a second embodiment of the present invention. Referring FIGS. 1 and 3, the first display panel 100 uses a reflection mirror RM and a color filter CF instead of the color selective reflection mirror CSM. The reflection mirror RM reflects a light incident from the outside. The color filter CF may include, but is not limited to, red R, green G, blue B. and white colors, and further include various colors such as yellow, cyan, and magenta. Accordingly, colors may be provided to the reflection light through the color filter CF. The transparent self-emission layer may include the first pixels PX capable of emitting visible light. The first pixels PX emit white light W and receive colors from the color filter CF.

FIG. 3 illustrates a structure in which the reflection mirror RM, the self-emission layer, the optical shutter, and the color filter CF are sequentially stacked. However, an embodiment of the present invention is not limited hereto. The present invention may include a structure in which positions of the optical shutter and the self-emission layer are changed.

A self-emission layer and an optical shutter are not necessarily adjacent to each other. The color filter CF including the first pixels PX and the reflection mirror RM including the second pixels PX′ may be disposed between the self-emission layer and the optical shutter.

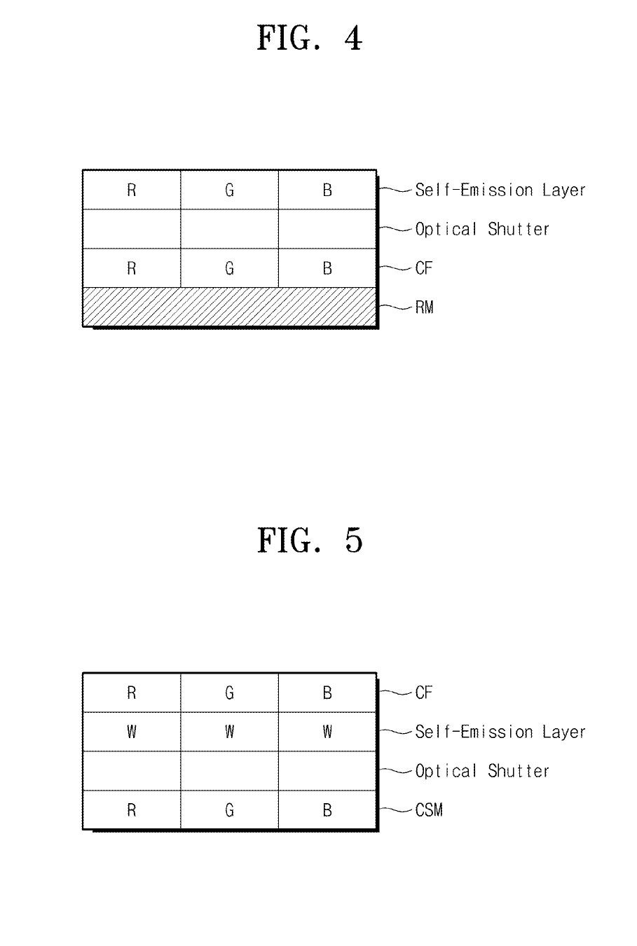

FIG. 4 is a block diagram illustrating a display panel structure according to the second embodiment of the present invention. Referring to FIG. 4, the display panel 100, 200 may include a structure in which the reflection mirror RM, the color filter CF, the optical shutter, and the self-emission layer are sequentially stacked. In addition, the self-emission layer may include, but is not limited to, red R, green G, blue B. and white colors, and further include various colors such as yellow, cyan, and magenta. The color filter CF may include colors corresponding to the respective first pixels PX of the self-emission layer.

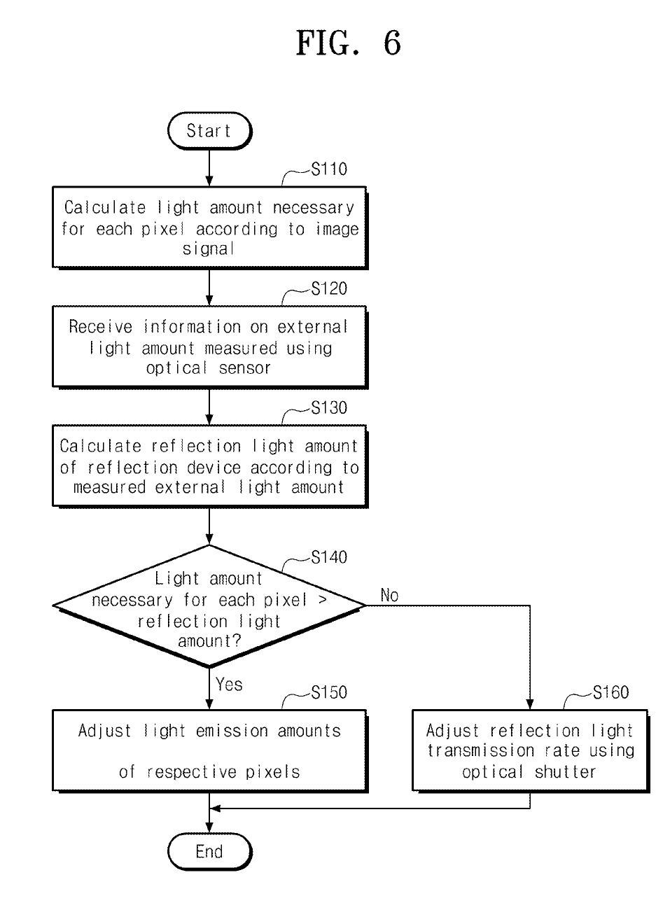

FIG. 5 is a block diagram illustrating a display panel structure according to a third embodiment of the present invention. Referring to FIG. 6, the display panel 100, 200 may include a structure in which the color selective reflection mirror CSM, the optical shutter, the self-emission layer, and the color filter CF are sequentially stacked. However, an embodiment of the present invention is not limited hereto. Positions of the optical shutter, self-emission layer and color filter of the display panel may be changeable.

FIG. 6 is a timing diagram illustrating a driving method of a display device according to an embodiment of the present invention. Referring to FIGS. 1 to 6, in step S110, a light amount necessary for each of the first pixels PX according to an image signal desired to be displayed are calculated. In detail, the timing controller 400 converts a data format of the image signals RGB received from the outside in order to be matched with interface specification of the first and second data drivers 600 and 800. The timing controller 400 provides the first and second image data DATA1 and DATA2 whose data format is converted to the first and second data drivers 600 and 800, respectively.

In step S120, information on an external light amount measured through the optical sensor 300 is received. In detail, the timing controller 400 receives the information on the external light amount measured by the optical sensor 300.

In step S130, an amount of the light reflected by a reflection device is calculated according to the external light amount. The reflection device may be a color selective reflection mirror CSM or a reflection mirror RM. The timing controller 400 calculates the amount of the light reflected by the color selective reflection mirror CSM or the reflection mirror RM according to the external light amount.

In operation S140, a light emission amount of each pixel and an amount of the reflection light that is reflected by the reflection device are compared. In operation S150, when the light amount necessary for each of the first pixels PX is greater than the reflection light amount according to the incident light amount, each of the first pixels PX further emits light as much as a necessary light amount to represent an image.

In step S160, when the light amount necessary for each of the first pixels PX is less than the reflection light amount according to the incident light amount, the timing controller 400 stops light emission of the first pixels PX. In addition, the timing controller 400 adjusts a transmission rate of the reflection light reflected through the color selective reflection mirror CSM or the reflection mirror RM. In detail, the timing controller 400 may adjust the output reflection light amount by adjusting the light transmission rate of the optical shutter.

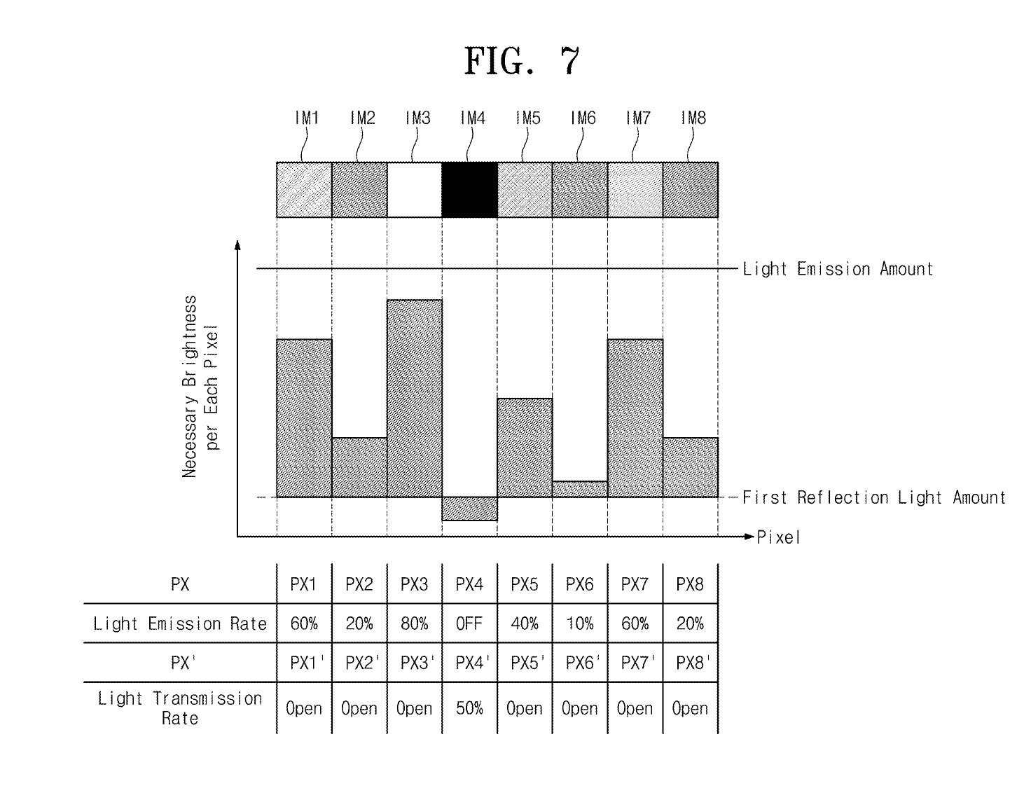

FIG. 7 is a graph showing an image displayed method according to a first embodiment of the present invention. Referring to FIGS. 1 to 7, the timing controller 400 according to an embodiment of the present invention may display an image through controls of the first and second display panels 100 and 200.

The timing driver 400 may calculate brightness necessary for each of the first pixels PX according to the image signal RGB received from the outside. In order to explain the present invention, it is assumed that first to eighth images IM 1 to IM 8 are displayed through eight pixels PX1 to PX8 and PX1′ to PX8′.

In order to explain FIG. 7, it is assumed that a reflection light amount of the color selective reflection mirror CSM or the reflection mirror RM of the first display panel 100 is a first reflection light amount.

The pixels PX1 to PX8 and PX1′ to PX8′ emit lights or adjust a transmission rate of the reflection light to displayed the images IM 1 to IM 8 according to the first reflection light amount. In detail, the first pixel PX1 requires a greater light amount than the first reflection light amount to displayed the first image IM 1. Accordingly, the first pixel PX1 emits the light to generate the light of necessary amount. For example, the first pixel PX may emit light as much as about 60% of a maximum light amount to display the first image IM 1. In addition, a first pixel PX1′ of the second pixels PX′ is in an Open state to transmit the light of the first pixel PX1.

The second and third pixels PX2 and PX3 also require greater light amounts than the first reflection light amount to display the second and third images IM 2 and IM 3. Accordingly, the second pixel PX2 may emit light as much as about 20% of a maximum light amount and the third pixel PX3 emits light as much as about 80% of a maximum light amount to display the second and third images IM 2 and IM 3. The second and third pixels PX2′ and PX3′ of the second pixels PX′ are in an Open state.

The fourth pixel PX4 has the first reflection light amount greater than the light emission amount necessary for realizing the fourth image IM 4. Accordingly, the timing controller 400 turns OFF light emission of the fourth pixel PX4. In addition, the timing controller 400 adjusts a light transmission rate of the fourth pixel PX4′ to about 50% and display the fourth image IM 4. The fourth image IM 4 may be displayed using the first reflection light amount.

The fifth to eighth pixels PX5 and PX8 also require greater light amounts than the first reflection light amount to display the fifth to eighth images IM 5 and IM 8. Accordingly, the fifth pixel PX5 may emit a light as much as about 40% of a maximum light amount, and the sixth pixel PX6 may emit a light as much as about 10% of a maximum light amount. In addition, the seventh pixel PX7 may emit a light as much as about 60% of a maximum light amount, and the eighth PX8 may emit a light as much as about 20% of a maximum light amount. The fifth to eighth pixels PX5 to PX8 may display the fifth to eighth images IM 5 to IM 8 through additional light emission in addition to the first reflection light amount. The fifth to eighth pixels PX5′ to PX8′ of the second pixels PX′ are in an Open state.

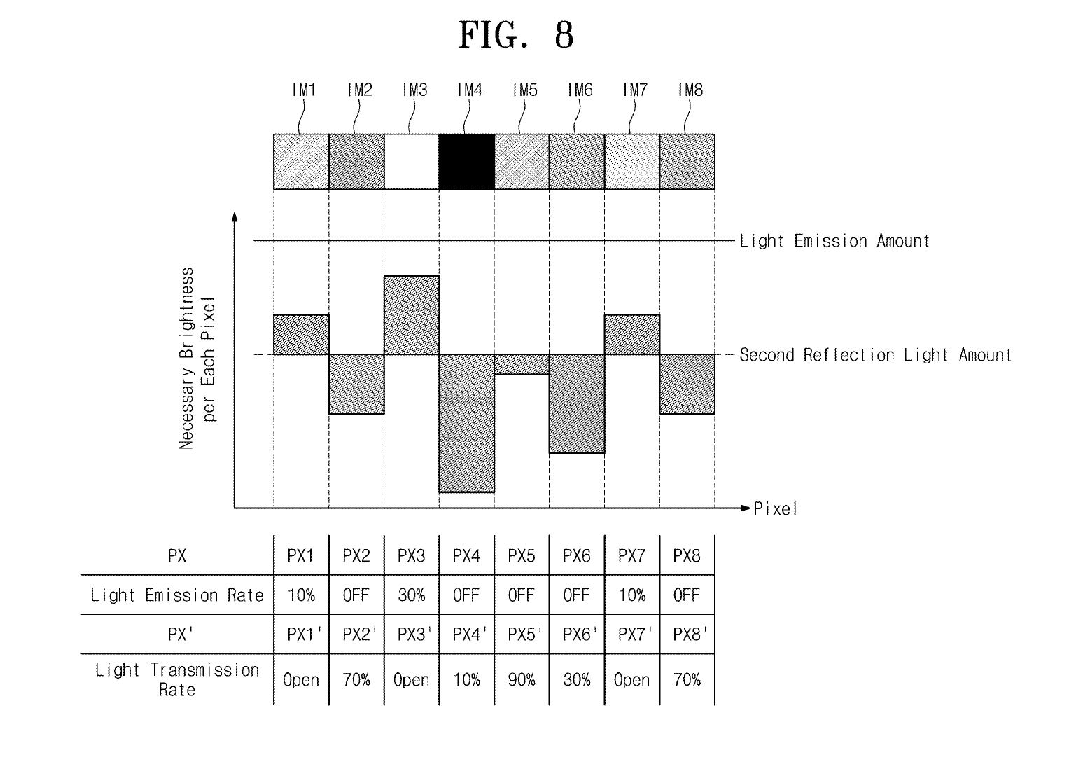

FIG. 8 is a graph showing an image realizing method according to a second embodiment of the present invention. In FIG. 7, an amount of an external light reflected by the color selective reflection mirror CSM or a reflection mirror RM is a second reflection light amount. For explanation, it is assumed that the second reflection light amount is greater than the first reflection light amount.

Referring to FIGS. 1 to 8, the first, third, and seventh pixels PX1, PX3, and PX7 require greater light amounts than the second reflection light amount to display the first, third, and seventh images IM1, IM3, and IM 7. Accordingly, the first, third, and seventh pixels PX1, PX3, and PX7 emit lights as much as about 10%, about 30%, and about 10% of maximum light emission amounts respectively to display the first, third, and seventh images IM1, IM3 and IM7. The first, third, and seventh pixels PX1,′ PX3′ and PX7′ of the second pixels PX′ are in an Open state.

The second reflection light amount is greater than a light emission amount that is necessary for the second, fourth, fifth, sixth, and eighth pixels PX2, PX4, PX5, PX6, and PX8 to display images, respectively. Accordingly, the timing controller 400 turns OFF light emission of the second, fourth, fifth, sixth, and eighth pixels PX2, PX4, PX5, PX6, and PX8 In addition, the timing controller 400 adjusts light transmission rates of the second, fourth, fifth, sixth, and eighth pixels PX2′, PX4′, PX5′, PX6′, and PX8′ of the second pixels PX′ to display the images IM2, IM4, IM5, IM6, and IM8. In detail, the timing controller 400 may adjust the transmission rates of the pixels PX2′, PX4′, PX5′, PX6′, and PX8′ to about 70%, 10%, 90%, 30%, and 70%, respectively.

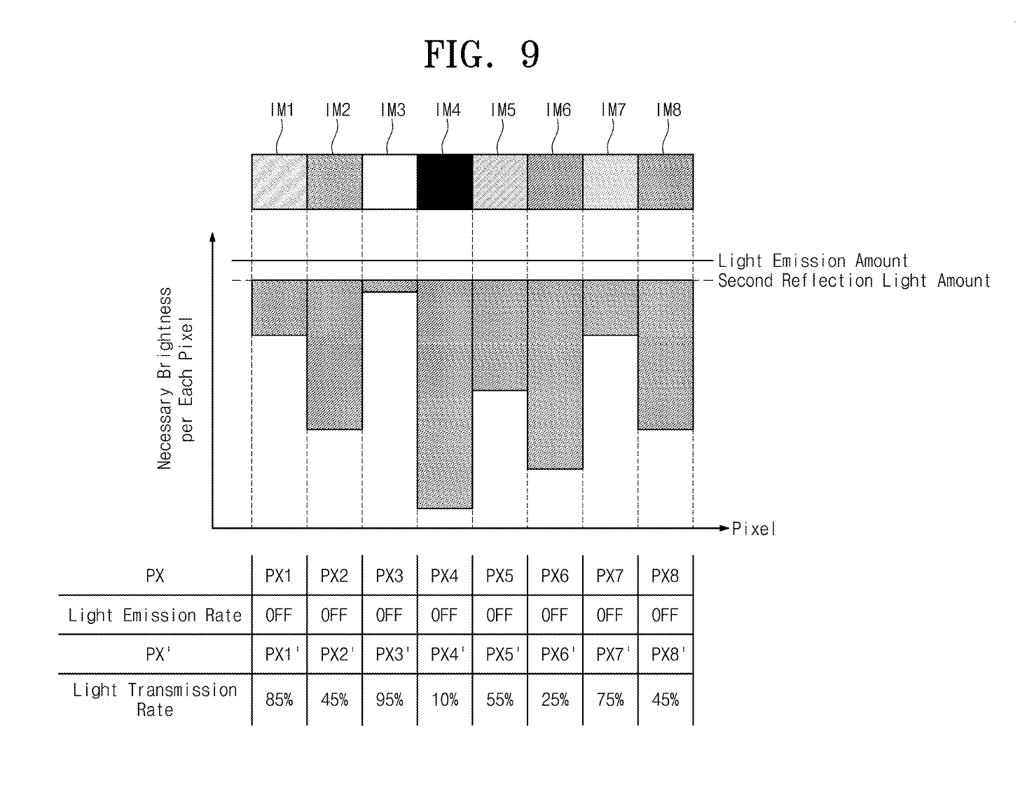

FIG. 9 is a graph showing an image realizing method according to a third embodiment of the present invention. In FIG. 8, an amount of an external light reflected by a color selective reflection mirror CSM or a reflection mirror RM is a third reflection light amount. For explanation, it is assumed that the third reflection light amount is greater than the second reflection light amount.

Referring to FIGS. 1 to 9, the third reflection light amount is greater than a light emission amount that is necessary for the pixels PX1 to PX8 to display the images IM1 to IM8, respectively. Accordingly, the timing controller 400 turns OFF light emission of the pixels PX1 to PX8. In addition, the timing controller 400 adjusts transmission rates of the pixels PX1′ to PX8′ included in the second pixels PX′ to display the images IM1 to IM8. In detail, the timing controller 400 may adjust the transmission rates of the pixels PX1′ to PX8′ to about 85%, 45%, 95%, 10%, 55%, 25%, 75%, and 45%, respectively, to display the images IM1 to IM8.

According to embodiments of the present invention, a display device and a driving method thereof can prevent degradation of a contrast ratio and improve power consumption by simultaneously using an organic light emitting display panel and a liquid crystal display panel as an optical shutter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A display device comprising:
a first display panel comprising first pixels emitting lights or transmitting an external light and a reflection mirror disposed on a bottom portion of the first pixels and reflecting the external light;
a second display panel adjusting a transmission rate of the external light reflected by the reflection mirror and comprising second pixels corresponding to the first pixels respectively;
an optical sensor measuring amounts of the external lights applied to the first and second display panels and outputting light information corresponding to the external light amounts;
a timing controller creating a first data control signal for adjusting light emission amounts of the first pixels and a second data control signal for adjusting transmission rates of the second pixels according to the light information;
a first gate driver providing a first gate signal for driving the first pixels;
a first data driver providing first data voltages for adjusting the light emission amounts of the first pixels in response to the first data control signal;
a second gate driver providing a second gate signal for driving the second pixels; and
a second data driver providing second data voltages for adjusting the light emission amounts of the second pixels in response to the second data control signal.

2. The display device of claim 1, wherein the reflection mirror is a color selective reflection mirror for applying colors to the external light.

3. The display device of claim 1, wherein the first display panel further comprises a color filter applying colors to the lights or the external light.

4. The display device of claim 1, wherein the first display panel is an organic light emitting display panel.

5. The display device of claim 1, wherein the second display panel is a liquid crystal display panel.

6. The display device of claim 1, wherein the second display panel is disposed over a top portion of the first display panel, and the first and the second pixels have one-to-one correspondence.

7. The display device of claim 1, wherein, when the external light amount is greater than the light emission amounts of the first pixels, the timing controller stops driving the first display panel and adjusts light transmission rates of the second pixels to display images through reflection light by the reflection mirror according to the light information.

8. A driving method of a display device comprising first pixels emitting lights or transmitting and reflecting an external light, and second pixels corresponding to the first pixels respectively, the driving method comprising:
calculating light emission amounts necessary for the respective first pixels for displaying an image signal;
receiving light information on the amount of the external light incident to the first and second pixels;
calculating a reflection light amount of a reflection device according to external light amount;
comparing the light emission amounts necessary for the respective first pixels with the reflection light amount; and
adjusting the light emission amounts of the respective first pixels according to a result of the comparing.

9. The driving method of claim 8, wherein in the adjusting of the light emission amounts, the second pixels transmit lights output from the first pixels.

10. The driving method of claim 8, further comprising displaying the image signal by stopping the light emission of the first pixels and adjusting transmission rates of the respective second pixels to control the reflection light amount, when the light emission amounts necessary for the respective first pixels are less than the reflection light amount.

11. The driving method of claim 8, wherein the reflection device is a color selective reflection mirror.

12. The driving method of claim 8, wherein the reflection device including a reflection mirror and a color filter.
